(19) United States
(12) Patent Application Publication
(10) Pub. No.: US 2013/0186927 A1
(43) Pub. Date: Jul. 25, 2013

(54) DEFLAGRATION NAIL GUN

(71) Applicant: Hon Kan CHEUNG, Hong Kong (HK)

(72) Inventor: Hon Kan CHEUNG, Hong Kong (HK)

(21) Appl. No.: 12/619,697

(22) Filed: Nov. 17, 2009

(30) Foreign Application Priority Data
Sep. 8, 2009 (CN) 200920177314.3

(51) Int. Cl. B25C 1/00

(52) U.S. Cl. CPC B25C 1/008
USPC 227/8

(57) ABSTRACT

This is a kind of deflagration nail gun with sliding components and percussion switch devices. Described percussion switch devices include: station-keeping U-shaped steel wire with a jumper; pivoted percussion switch base with a notch at the back of its upper edge; ignition switch fixed on percussion switch base, with a prominent button upward; touch switch chip, of which, one of its end can be pivoted installed in the ignition switch, another end can extend from percussion switch base to the top touch chip on the top of notch, and the central of touch switch chip is joined to touch button. When the sliding component is located in the front-side position and the upper edge of percussion switch base is located at the bottom of jumper of U-shaped steel wire, the jumper can prevent switch base being pivoted along the direction of triggering. When the sliding component is located in the back-side position, the notch of percussion switch base is located under the jumper of U-shaped steel wire, which allows switch base to pivot along the direction of triggering. A deflagration nail gun with higher security can avoid the accidental shooting of nails causing human harm.

### BACKGROUND OF THE INVENTION

1. Technical Field

The utility model is relating to the deflagration nail gun, and has a percussion system with higher security.

2. Description of Related Art

Workers in the construction, decorating and furniture industries, when assembling wooden means, concrete and steel means, usually use a nail gun. Nails can be fired at high speed by using a nail gun, and instantly launched into fixed-pieces.

Common nail guns currently include the spring-loaded nail gun, pneumatic nail gun and deflagration nail gun.

The deflagration nail gun is one of highlights of the recent market. It has an explosion cylinder which can be supplied with combustible gas, and there is a small fan which can mix combustible gas with air. By igniting the mixture of air and combustible gas in the explosion cylinder, the explosion inside the cylinder provides explosive power to push the piston of the cylinder forward, the piston rod shocks the nail in the nail tube and shoots the nail out.

Deflagration nail guns are generally equipped with security measures to avoid people being shot accidentally with a nail. The common security measure is safety detent equipment, in which the piston or piston rod can be fixed. To release the detent, the nail gun must be aligned to a working surface to push nail tube. Such a safety measure can reduce the risk of injury, but is still not perfectly safe. For example, when the trigger of a nail gun is under the triggering state, and the nail gun is aligned to any working surface and pressed, the nail gun may shoot the nail out automatically. So if a person presses the nail gun onto his or someone else by accident, a nail may shoot out.

In order to reduce this risk, some manufacturers equipped the inside of nail guns with sequential tripping equipment. When using this kind of nail gun, you must release the trigger and then pull the trigger if you want to shoot a nail out. However, such a security measure can't avoid the nail being shot out if a person accidentally pulls the trigger even when the nail gun isn't pressed against a working surface.

Therefore, the security of operating a deflagration nail gun needs improvement, so as to avoid the nail accidentally being shot out.

### BRIEF SUMMARY OF THE INVENTION

The technical problem that needs to be solved by this utility model is to avoid the traditional deflagration nail gun shooting the nail out accidentally.

Therefore, this utility model provides a deflagration nail gun which includes:

Chassis:

Nail tube, fixed core set, four-claw frame and explosion cylinder are connected in turn from the front to the back;

Cylinder head fixed-installed in the back of chassis;

Fixed-installed (relative to the chassis) and located in the cylinder of explosion cylinder and four-claw frame as described above;

Piston sliding front and rear in the above cylinder;

Piston rod—its back-end is connected to the above piston, the front-end is inserted into the fixed core set and is suitable for pushing into above nail tube; and

Start switch devices of percussion operation of deflagration nail gun.

The characteristics of the above percussion switch devices include:

Station-keeping U-shaped steel wire, fixed at the bottom of above explosion cylinder, has a jumper and two arms linked with it and back extended, nail tube, fixed core set, four-claw frame, explosion cylinder and station-keeping U-shaped steel wire as described above forming a sliding component which can slide in the front-side and back-side and is suitable for the above chassis;

Percussion switch base which can be pivoted-fixed in the chassis, and has a notch at the back of the upper edge of above percussion switch base;

Ignition switch fixed on the above percussion switch base, with a prominent button upward; and

Touch switch chip—one of its ends can be pivoted installed in the ignition switch, another end can extended from percussion switch base to the top touch chip on the top of the notch, the central of touch switch chip joins the touch button.

When the sliding component is located in the front-side position, the upper edge of percussion switch base is located at the bottom of jumper of U-shaped steel wire, and the jumper can prevent the switch base from pivoting along the direction of triggering ignition switch.

When the sliding component is located in the back-side position, the notch of the percussion switch base is located at the bottom of the jumper of U-shaped steel wire, which allows switch base to be pivoted along the direction of above triggering.

Preferably, when the described sliding component is in the described back-side position, it will form a closed explosion chamber in described explosions cylinder.

Preferably, described deflagration nail gun will also include a resilience reset device, and it will push described sliding components forward.

Preferably, described percussion switch will also include a trigger. This trigger will be installed in the chassis by sliding front-to-rear; it will have exposed moving parts and pulling part extended from trigger part; and there will be a pulling pin at the front of described pulling part which can be inserted in the driving slot of described percussion switch.

Preferably, described percussion switch will include two parallel base plates and one pivot sleeve vertical to these base plate, and the percussion switch base will be installed in the chassis through pivot of the pivot sleeve, and form described driving slot in each described base.

Preferably, the ignition switch mentioned above will be installed between two base plates; there will be a guiding convex formed on the ignition switch and a guiding groove formed in the inner surface of base plate; described guiding convex is inserted in this guiding groove.

Preferably, when the described sliding component is in its back-side and described percussion switch is pivoted along the direction of triggering, described jumper of station-keeping U-shaped steel wire will push the contacted part in the notch in order to press contacted button by touch switch chip.

Preferably, fans and combustible gas nozzle will be set for the described cylinder head.

Preferably, one or more holes penetrating the sides will form in the front side of described cylinder, a one-way valve will be installed in these holes and therefore the air will flow out of the cylinder but will not flow into the cylinder.

Preferably, above nail tube, fixed core set, four-claw frame, explosion cylinder, piston, piston rod, and cylinder will have a common center line extending along the front and rear direction.

According to this utility model, the deflagration nail gun will be equipped with a higher security percussion system, and firing will only be possible after the trigger is released and the nail tube is pressed against a working surface again. Therefore, its higher security will avoid accidental shooting of nails.

### BRIEF DESCRIPTION OF THE DRAWINGS

FIG. 1 is the constructed profile of this utility model of deflagration nail gun in the state of not being used.

FIG. 2 is the constructed profile of major operation part of this utility model of deflagration nail gun.

FIG. 3 is the constructed profile of this utility model of deflagration nail gun in the state of nail tube being pushed.

FIG. 4 is the constructed profile of this utility model of deflagration nail gun in the state of burning and exploding combustible gas in the explosion chamber after pulling the trigger.

FIG. 5 is the constructed profile of this utility model of deflagration nail gun in the state of piston resetting automatically after burned and exploded combustible gas in the explosion chamber.

### DETAILED DESCRIPTION OF THE INVENTION

The following is the description of the utility model deflagration nail gun according to the reference figures.

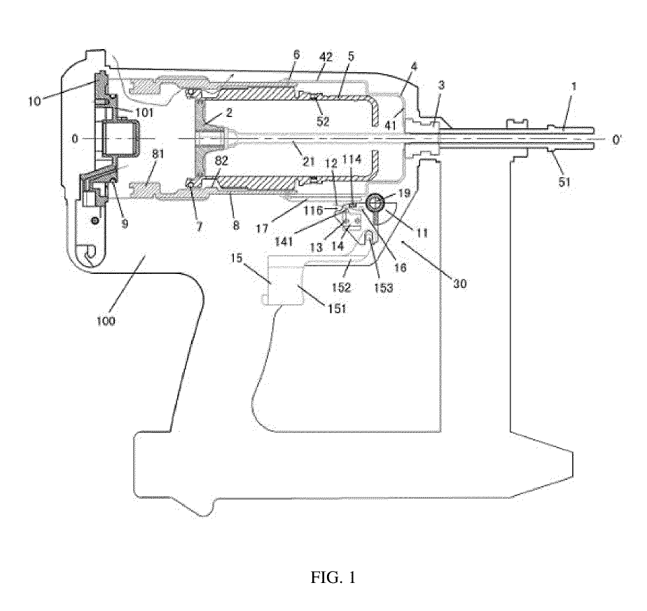

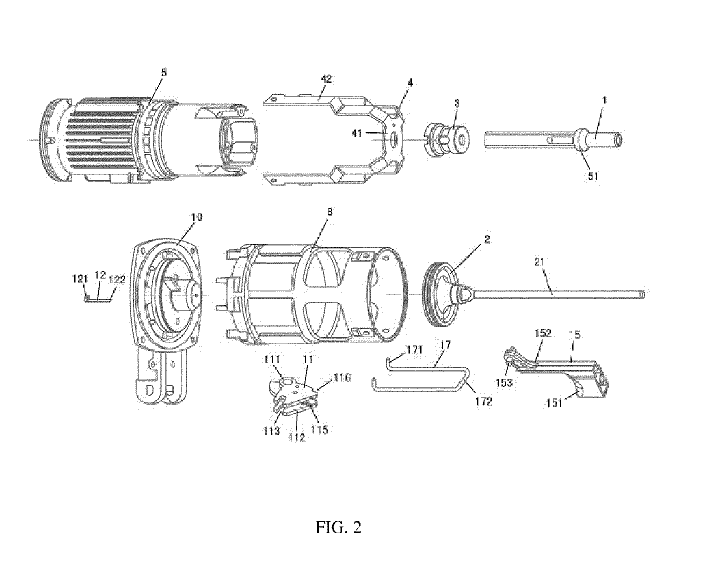

Refer to FIG. 1 and FIG. 2—deflagration nail gun using one of the preferable implementation methods of utility model includes the following parts: chassis 100; nail tube 1; piston 2; piston rod 21; fixed core set 3; four-claw frame 4; cylinder 5; explosion cylinder 8; cylinder head 10; percussion switch device 20. The following is a detailed description of these parts.

First of all, similar to the structure of traditional deflagration nail guns, this utility model deflagration nail gun has chassis 100 with a comfortable handle for the user; it can install and accommodate various parts of nail gun. Understandably, chassis 100 is not a single part, but it is formed by many chassis parts. The shape of chassis 100 is symmetrical to the vertical center plane extended front and rear in the rough.

Nail tube 1 can be installed at the top of front-side of chassis 100 by sliding front and rear, nail (not shown) can be inserted in the nail tube 1, for example, inserted into the inner hole from the front end of the nail tube 1, while the front end of piston rod 21 can enter into inner hole of nail tube from the front end of nail tube 1 and hit the nail, then shoot nail out forward.

Fixed core set 3 has been concentrically installed in the back end of the nail tube 1. Fixed core set 3 has a fixed core hole aligned with the inner hole. The front end of piston rod 21 is inserted into fixed core hole of fixed core set 3 in order to enter the inner hole of the nail tube correctly.

Four-claw frame 4 is fixed to the back end of fixed core set 3, four-claw frame 4 has disc 41 adjacent to the back end of fixed core set 3 and four connecting arms 42 extending back from disc. The front of explosion cylinder 8 is fixed to the back-end of connecting arm 42 by using bolt 6, and the outer side of explosion cylinder 8 can match chassis 100 by sliding.

Therefore, we can see that nail tube 1, fixed core set 3, four-claw frame 4, explosion cylinder 8 and station-keeping U-shaped steel wire 17 described below can be fixed to form a front-to-rear sliding component. Cylinder head 10 is fixed-installed in the rear of chassis, and has bulge 101 which has outside border O-shaped sealing ring 9.

When the user grips the nail gun and pushes the front end of nail tube 1 on an object such as a working surface, and then continues to move the nail gun forward, pushing power borne by nail tube will move backward the sliding component formed by nail tube 1, fixed core set 3, four-claw frame 4, explosion cylinder 8 and station-keeping U-shaped steel wire 17 until the back end of explosion cylinder 8 arrives at the cylinder head 10 and/or snap flange 51 expended outward of nail tube 1 arrives at the corresponding part of chassis. At this time, O-shaped sealing ring 9 and inner side of flange 81 extended inward at the back-end of explosion cylinder 8 forms a sealing surface. In addition, the sliding component is equipped with a resilience reset device (not shown) in order to move the sliding component forward. When the sliding component moves forward, disc 41 of four-claw frame 4 will touch the corresponding position of the chassis, and stop the sliding component moving forward.

Cylinder 5 is installed in the explosion cylinder 8. Like cylinder head 10, cylinder 5 is fixed in the chassis, so the location of two parts is relatively stationary.

When the explosion cylinder 8 moves backward, flange 82 extended inward in the middle of explosion cylinder 8 will move to the outer side of back-end 53 of cylinder 5, thus described flange 82 extended inward will match outer side of back-end 53 by sliding. At the same time, described flange 81 extended inward will match bulge 101 mentioned above by sliding.

In addition, in order to insert the back-end of explosion cylinder 8 in the cylinder head 10, there is a guiding bulge 83 extended backward at the back-end of explosion cylinder 8, and a corresponding part of guiding bulge 83 on the cylinder head 10. When the explosion cylinder 8 moves backwards, guiding bulge 83 will match the corresponding part, thus causing the explosion cylinder 8 to be placed in the correct position of cylinder head 10.

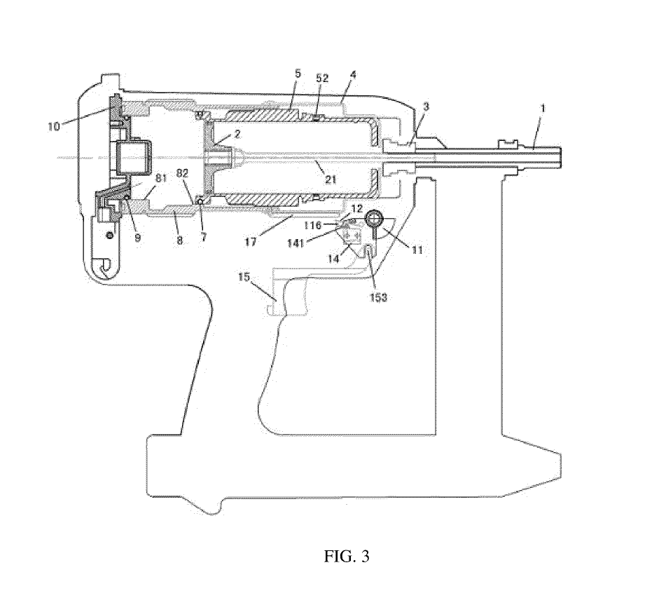

In addition, O-shaped sealing ring 7 is installed on the outer wall 53 of described back-end. When explosion cylinder 8 is located in the back position, a sealing is formed between above O-shaped sealing ring 7 and bulge 82 extended inward, thus cylinder 5 and cylinder head 10 will close explosion cylinder 8 (see FIG. 3). When the explosion cylinder 8 moves from the back-side position to forward, O-shaped sealing ring 7 is disengaged from bulge 82 extended inward, thus cylinder 5 and cylinder head 10 will open explosion cylinder 8 (see FIG. 1)

One or more holes 52 penetrating the side are formed in the front of cylinder 5. One-way valve is installed in these holes 52 and therefore the air can flow out of cylinder 5 but can't flow into the cylinder.

Piston 2 is fixed on the back end of piston rod 21, and can front-to-rear slide in the barrel of cylinder 5 with piston rod.

The center lines of nail tube 1, fixed core set 3, four-claw frame 4, explosion cylinder 8, cylinder 5, piston 2, piston rod 21 and cylinder head 10 are collinear, namely they have collinear center line 0-0′ extended along the front and back direction, as shown in FIG. 1. This center line 0-0′ is located in the vertical center plane.

Percussion switch device 20 is installed under the four-claw 4 in the chassis to control the firing operation of nail gun. Percussion switch device 20 includes percussion switch base 11, touch switch chip 12, ignition switch 14, trigger 15, and station-keeping U-shaped steel wire 17. Detailed instructions follow.

Percussion switch base 11 includes two parallel base plates 112 and one pivot sleeve 111 vertical to these base plates, percussion switch base 111 is installed in the chassis 100 through pivot 19 of the pivot sleeve 111, pivot 19 is perpendicular to vertical center plane mentioned above, thus percussion switch base 11 can pivot around pivot 19. Described bases 112 have driving slot 113 extended downwards.

Trigger 15 can be installed in the chassis by front-to-rear sliding, and expose buttoning part 151 used for buttoning backwards and pull part 152 stretched forward. The front of pull part 152 has two pull pins 153, and these pull pins 153 are inserted in the driving slot 113 of base 112. Normally, trigger 15 is pushed down to the forward stretched position by a built-in spring. At this point, the user pushes back and presses buttoning part 151 with a finger and trigger 5 moves backwards, thus pull pin 153 will make percussion switch base 11 rotate around pivot 19 and along the trigger direction (clockwise direction in FIG. 1).

Touch switch chip 12 is installed between two base plates 112. One end of touch switch chip has pivot installation part 121, and another end is touch part 122. On pivot installation part 121, touch switch chip 12 can be pivoted installed in the position between two base plates 112 by using pin 16. Pin 16 is also perpendicular to above vertical center plane. Touch switch chip 12 extends backward and upward from other pivot installation part 121, thus touch part 122 extends backward from percussion switch base 11.

Ignition switch 14 is installed between two base plates 112. Such ignition switch 14 is fixed on one or two base plates 112 by using screw 13, and is located under the touch switch chip 12. In order to locate ignition switch 14 between two base plates 112, there is guiding bulge on one or two sides of the bottom of ignition switch 14, this guiding bulge can be inserted in the guiding groove 115 formed in the inner wall of base plates 112 in order to locate the ignition switch 14 relative to the percussion switch base 11.

Ignition switch 14 has a contact button 141 extended upward. Pressing contact button 141 can start the ignition switch 14. The middle part of touch switch chip 12 is joined on the contact button 141, so the touch switch chip 12 is located between stopping block 114 of percussion switch base 11 and contact button 141 of ignition switch 14, and can press contact button 141 by pivoting pin 16 relative to the ignition switch 14, to start ignition switch 14.

Station-keeping U-shaped steel wire 17 is a one-piece with a jumper 172 formed by bending a steel wire and two arms extended backwards. Each of these two arms has end 171 which can be used for fixing station-keeping U-shaped steel wire 17 on the bottom of explosion cylinder 8. When the nail tube mentioned above is pushed backwards, station-keeping U-shaped steel wire 17, as one of the sliding components, will move backwards.

When sliding components move to the front position, as shown in FIG. 1, the upper edge of two base plates 112 of percussion switch base 11 is adjacent to the jumper 172 of station-keeping U-shaped steel wire 17, preventing the percussion switch base 11 pivoting along the triggering direction.

In addition, notches 116 are formed at the upper edge of two base plates 112 of percussion switch base 11. Touch part 122 described above extends to the top of touch surface. When the sliding components move to the back position, above notch 116 can push and press touch part 122, and snap the jumper 172 of station-keeping U-shaped steel wire 17, allowing the percussion switch base 11 to be pivoted along the triggering direction.

This means that only when the sliding component moves to the back position which can close explosion cylinder 8, trigger 15 can be pulled, and then ignition switch 14 can be started. In the state of opening explosion cylinder 8, trigger 15 can't be pulled, and then ignition switch 14 can't be started.

When the whole sliding component moves to the back position, as mentioned above, pulling the trigger 15 backwards will result in percussion switch base 11 moving around pivot 19 along the direction of triggering, percussion switch base 11 will take the touch switch chip 12 to this position, that is the touch part 122 of touch switch chip 12 touch the jumper 172 of station-keeping U-shaped steel wire 17. As the percussion switch base 11 moves along the triggering direction and ignition switch 14 moves upwards, touch part 122 prevented by jumper 172 will press the contact button 141 of ignition switch 14, then start ignition switch 14. At this time, notch 116 at the back of upper edge of two base plates 112 of percussion switch base 11 will snap the jumper 172 of station-keeping U-shaped steel wire 17.

The following describes the operation of this utility model deflagration nail gun.

In the state of nail gun being not operated, each part is located in the position as shown in FIG. 1, the sliding component formed by its nail tube 1, fixed core set 3, four-claw frame 4, explosion cylinder 8 and station-keeping steel wire 17 is located in the front side, and the explosion cylinder 8 is open. At this time, jumper 172 of station-keeping U-shaped steel wire 17 will be adjacent to the upper edge of two base plates 112 of percussion switch base 11, and thus the trigger 15 can't be pulled.

Next, by pushing and pressing the nail tube 1 on a working surface and pushing it into the chassis, the sliding component will move backwards to the back-side position, as shown in FIG. 3. At this time, explosion 8 is closed to form the close explosion chamber in the explosion cylinder. The outer border of this explosion chamber is limited by explosion cylinder, its front-end is limited by cylinder 5 and piston 2, and its back-end is limited by cylinder head 10. The jumper 172 of station-keeping U-shaped steel wire 17 will move backwards and align with the notch 116 of percussion switch base 11, allowing trigger 15 to be pulled.

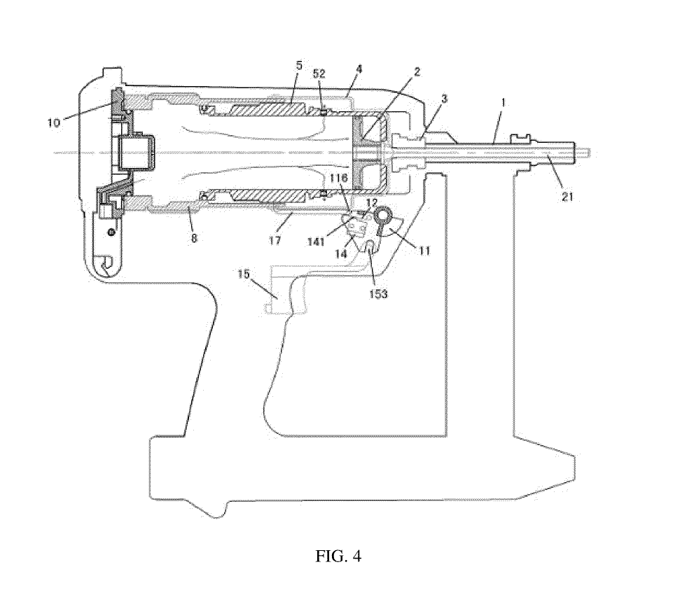

Then, inject the combustible gases into explosion chamber. Pulling the trigger 15 can cause percussion switch base 11 with touch switch chip 12 and ignition switch 14 to turn along the triggering direction. When the touch part 122 of touch switch chip 12 touches the jumper 172 of station-keeping U-shaped steel wire 17, the turning of touch switch chip 12 is stopped, and the ignition switch 14 will turn with percussion switch base 11, which means ignition switch 14 will move upwards and will result in contact button 141 pressing into ignition switch 14 by touch switch chip 12, thus closing the ignition switch 14 and connecting the ignition circuit in order to realize ignition in the explosion chamber. The combustible gas and air mixture in the explosion chamber are exploded and burned, resulting in the expansion of high-temperature and high-pressure gas, as shown in FIG. 4, piston 2 with piston rod 21 is pushed backwards by the high-temperature and high-pressure gas, the front end of piston rod hits the nail located in the nail tube 1 and shoots the nail out. Extra high-temperature and high-pressure gas are discharged through the hole 52 of the side of cylinder 5.

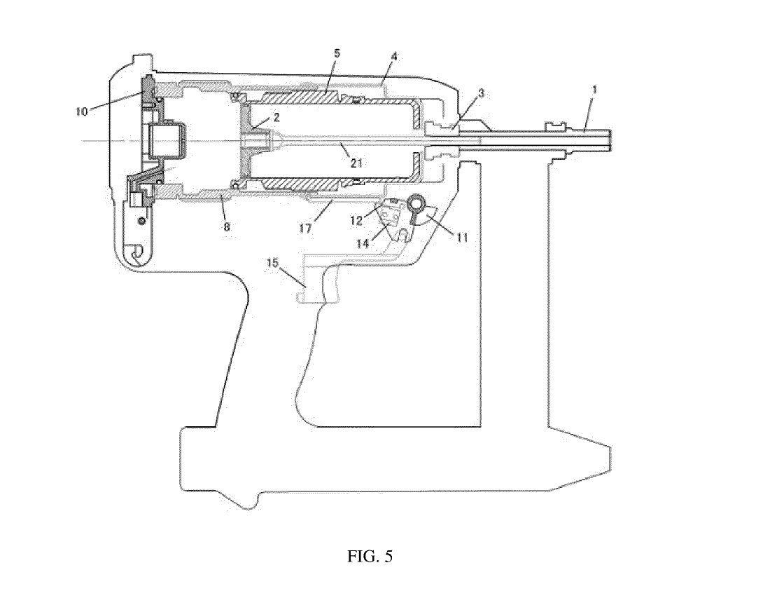

Once fired, because outside air can't enter cylinder 5 through the hole 52 of cylinder 5 side, the explosion cylinder (explosion chamber) can still be seen as a closed chamber relative to the outside at this time. High-temperature air in the closed explosion cylinder begins to cool and form a low pressure. Namely, the inner side of piston 2 forms a low pressure while outer side of piston is under the atmospheric pressure. Under the pressure difference between inner side and outer side of piston 2, piston 2 and piston rod 21 move backwards to reset, as shown in FIG. 5. During the period which piston and piston rod are reset by the effect of pressure difference, jumper 172 of station-keeping U-shaped steel wire 17 continues to snap the notch 116 of percussion switch base 11 to prevent above sliding component moving forward, thus ensuring low pressure in the explosion cylinder until the piston and piston rod finish resetting.

Provide the following security guarantees according to this utility model. As shown in FIGS. 1, 3, 4, and 5, pulling trigger can only be done in the state of explosion cylinder being closed completely, and then percussion switch base 11 is turned and starts ignition switch 14. In addition, during turning, touch switch chip 12 starting ignition switch 14 and notch 116 of percussion switch base 11 snapping station-keeping U-shaped steel wire 17 can be done at the same time, or start ignition switch 14 to realize firing firstly, and then station-keeping U-shaped steel wire 17 is snapped by notch 116 of percussion switch base 11. This method effectively prevents the following unsafe operation: if firing after the notch 116 of percussion base 11 snapped station-keeping U-shaped steel wire 17, it is unsafe because nail tube may fire when leaving the working face.

After fire and the piston rod reset automatically, release the trigger 15 and reset the trigger forwards by the flexibility of trigger built-in spring, as shown in FIG. 1. Driven by the trigger, percussion switch base 11 will turn and reset along the resetting direction (counter-clockwise as shown in FIG. 1). Resetting of percussion switch base will result in the circuit being off. At the same time, notch 116 of percussion switch base 11 leaves station-keeping steel wire 17 and above sliding component may move forward to the front-side position under the effect of resilience reset device (as shown in FIG. 1).

It can be understood that the fans equipped for explosion chamber can mix the blasted combustible gas and air. Preferable fan position is in the cylinder head 10. Preferable cylinder head 10 also has the nozzle used for introducing combustible gas into the explosion chamber.

Preferably, when nail tube 1 is pushed and pressed backwards (viz. into the chassis), explosion cylinder 8 will connect the fan switch first when explosion cylinder moves backward, pulling the trigger and connecting the ignition switch. As shown in FIG. 3, it can be seen that trigger 15 can be pulled one or more times. However, when the nail tube is pushed and pressed, the combustible gas introduced into explosion chamber is quantitative, so the combustible gas in the explosion chamber can be lit once. Thus, after pulling the trigger 15 and light successfully, nail tube must be pushed and pressed again to introduce combustible gas into the explosion chamber, then it can be lit again. Therefore, the utility model deflagration nail gun has greater security.

Moreover, according to the utility model, the trigger can be pulled after pressing the nail tube. This avoids the risk mentioned above of safe detent device firing accidentally by using existing technologies.

In addition, according to the utility model, the trigger must be released first after firing, then the next pressing nail tube and pulling trigger can be done, thus providing twice the insurance measures compared to the technology of sequential tripping used in traditional technologies, and greatly enhancing the safety level.

1. This kind of deflagration nail gun includes:
chassis:
nail tube, fixed core set, four-claw frame, and explosion cylinder are connected in turn from the front to the back;
cylinder head fixed-installed in the back of chassis;
fixed-installed (relative to the chassis) and located in the cylinder of explosion cylinder and four-claw frame as described above;
piston sliding front and rear in the above cylinder;
piston rod—its buck-end is connected to the above piston, the front-end is inserted into the fixed core set and suitable for pushing into above nail tube; and
start switch devices of percussion operation of deflagration nail gun;
the above percussion switch devices include:
station-keeping U-shaped steel wire, fixed at the bottom of above explosion cylinder has jumper and two arms linked with it and extended back, nail tube, fixed core set, four-claw frame, explosion cylinder and station-keeping U-shaped steel wire as described above forming a sliding component which can slide in the front-side and hack-side and is suitable for the above chassis;
percussion switch base can be pivoted-fixed in the chassis, and has a notch at the back of the upper edge of above percussion switch base;
ignition switch fixed on the above percussion switch base, with a prominent button upward; and touch switch chip—one of its ends can be pivoted installed in the ignition switch, another end can extend from percussion switch base to the top touch chip on the top of notch, the central of touch switch chip joins to touch button; when the sliding component is located in the front-side position and the upper edge of percussion switch base is located at the bottom of jumper of U-shaped steel wire, the jumper can prevent switch base being pivoted along the direction of triggering ignition switch; when the sliding component is located in the back-side position and the notch of percussion switch base is located at the bottom of the jumper of U-shaped steel wire, the switch base is pivoted along the direction of above triggering.

2. The deflagration nail gun as set forth in claim 1, which is characterized in that when the described sliding components are in the described hack-side position, it will form a closed explosion chamber in described explosions cylinder.

3. The deflagration nail gun as set forth in claim 2, which is characterized in that it also includes resilience reset device, and it will push described sliding components forward.

4. The deflagration nail gun as set forth in claim 1, which is characterized in that described percussion switch also includes a trigger, which is installed in the chassis by sliding front-to-rear; it has exposed moving parts and pulling part extended from trigger part; and there is a pulling pin at the front of described pulling part, which can be inserted in the driving slot of described percussion switch.

5. The deflagration nail gun as set forth in claim 4, which is characterized in that described percussion switch includes two parallel base plates and one pivot sleeve vertical to these base plates; percussion switch base is installed in the chassis through pivot of the pivot sleeve and forms described driving slot in each described base.

6. The deflagration nail gun as set forth in claim 5, which is characterized in that ignition switch mentioned above is installed between two base plates, there is orientation convex formed on the ignition switch, and orientation groove formed in the inner surface of base plate, described orientation convex is inserted in this orientation groove.

7. The deflagration nail gun as set forth in any one of claims 1 to 6, which is characterized in that when the described sliding components is in its back-side and described percussion switch is pivoted along the direction of triggering, described jumper of station-keeping U-shaped steel wire will push the contacted part in the notch in order to press contacted button by touch switch chip.

8. The deflagration nail gun as set forth in any one of claims 1 to 6, which is characterized in that fans and combustible gas nozzle are set for the described cylinder head.

9. The deflagration nail gun as set forth in any one of claims 1 to 6, which is characterized in that one or more holes penetrating the side are formed in the front side of above cylinder, one-way valve is installed in these holes and therefore the air can flow out of cylinder but can't flow into cylinder.

10. The deflagration nail gun as set forth in any one of claims 1 to 6, which is characterized in that above nail tube, fixed core set, four-claw frame, explosion cylinder, piston, piston rod and cylinder have a common center line extending along the front and rear direction.
